(19) United States
(12) Patent Application Publication
(10) Pub. No.: US 2003/0097594 A1
(43) Pub. Date: May 22, 2003

(54) System and method for privacy protection in a service development and execution environment

(76) Inventor: Alain Penders, Broomfield, CO (US)

Correspondence Address: Barry E. Bretschneider, Morrison & Foerster LLP, Suite 5500, 2000 Pennsylvania Avenue, N.W., Washington, DC, 20006-1888, US

(21) Appl. No.: 10/137,338

(22) Filed: May 3, 2002

Related U.S. Application Data
(60) Provisional application No. 60/288,076, filed on May 3, 2001.

(51) Int. Cl. H04L 9/00

(52) U.S. Cl. 713/201

(57) ABSTRACT

A system and method for privacy protection in a service development and execution environment. Service Creators can create services using a development environment. End users can run those services using an execution environment, and can safely provide private information to the services. Together, the development and execution environments ensure that no private information can be transmitted to a recipient without the end users explicit permission. For each piece of information used by an executing service, it is tracked whether or not it is private, and to whom it is private, allowing certain pieces of information to be public to family, for example, but private to everyone else. When the service wants to transmit information to a recipient, the Privacy Firewall rules are used, and ensure that either the information is not private for the recipient, or the end user has explicitly approved the transmission, or the transmission is denied (and will not happen).

### FIELD OF THE INVENTION

The present invention relates to development and execution environments that provide data services to users. More particularly, the invention is a development environment that allows a service creating entity, whether human or programmatic, to create a data service that accesses private information about a user who executes the data service in the context of an execution environment running the data service on behalf of a user. Combined, the development environment and execution environment protect the privacy of the user's private information during execution of the service.

### BACKGROUND OF THE INVENTION

As used herein, the term “service” refers to an application that uses information technology, such as computers, computer or telecommunications networks, communication protocols, wireless devices, computer languages, etc. to provide functionality to an end user, whether human or programmatic. A service may include, for example, ordering food, or sending specific information to a user.

Sun's Java Virtual Machine implements applets, which are downloaded by a user's web browser, and executed on a user's device (usually a personal computer). As potentially malicious people may have developed these applets, the Java language implements a security mechanism that prevents the executing applet from performing insecure actions on a user's device. These insecure actions include, for example, reading files, getting configuration information from the device, deleting files, and formatting the hard disk. This approach also protects the privacy of the user, as the applet cannot access files or other information that may contain private information. When a user lowers the security level of the Java Virtual Machine, the applet gains access to all files and information, because the Java Virtual Machine assumes the user trusts the applet. Thus, the user loses control over which information the applet can access. Also, when the applet requests the user to enter private information such as a credit card number, the user relinquishes control over information provided to the applet. For example, whether or not this information is transmitted to an unknown third party without the knowledge of the end user.

The Microsoft Passport system provides a database (so called eWallet) in which information about the Passport member is stored. When visiting or shopping at a website participating in the Passport program, the member can request this information to be securely transmitted from the database to the website so that the member does not have to enter the information. This information can include confidential data such as the users credit card number. Microsoft Passport acts as an approval authority which companies that provide e-commerce functions via their websites are allowed to join. When a company's website breaks the privacy guidelines set by the Passport program, it can be removed. Such a system provides the user with a convenient method of reducing the amount of information they need to enter during each transaction; and further, the user receives an increased level of security for their personal and financial information. However, the user has limited control over what information is released to the website. The developer of the website cannot simply create it and make it available, but must first meet the requirements of the Microsoft Passport program to be enrolled in the program.

With both of these approaches, whenever private information is required to make a decision in the service provided by an applet or an e-commerce web site (even if the service creator doesn't need to know the information), the information must be made available to the service, and the user loses control over what the service does with the private information.

Often a trusted party who is in possession of private information about users makes contractual agreements with multiple service providers/creators to guarantee that the developed services will not abuse private information. While legally binding, these agreements do not technically prevent abuse, for example, by a malicious employee or a hacker. Additionally, in several countries there have been laws passed which forbid trusted parties such as the users telecom provider to pass private information about a user on to 3rd parties without the prior consent of the user.

Given the rising popularity of electronic transaction conducted over distributed networks such as the internet, it is becoming increasingly important to have a system that permits a user to provide necessary personal and financial information in a manner that allows them to minimize the possibility of unauthorized and perhaps illegal uses of their personal and financial information.

### SUMMARY OF THE INVENTION

The present invention provides an environment, which allows a service creating entity to create a service that can be executed by an end user. The developer (service creating entity) could be an end user, but may also be, for example, a content provider or content aggregator. Within the environment, the end user can make private information available to the service, without risk that the service will maliciously or otherwise transmit the information to the service creator or a third party without the explicit permission of the end user. This allows the end user to safely provide confidential information to the service, so that the service can be more personalized (e.g., the service behavior changes depending on the age of the end user, which is private information about the end user), or the service can perform tasks specific for the end user (e.g., automatically trade a stock when it goes above or below a certain value, using private information about the end user). When the service has to provide private information to the service creator or a third party, the environment will explicitly ask the end user for permission. This includes informing the end user of exactly what information will be transmitted, and to whom the information will be transmitted.

In accordance with an embodiment of the invention, a development environment is provided for a service creating entity to create a service. When the service creating entity completes the creation of the service, the output of the development environment is a service that can be run by the execution environment.

In accordance with another embodiment of the invention, an execution environment is provided for an end user of a service, allowing the end-user to run a specific service. The combined development and execution environment is referred to as the environment.

In accordance with an aspect of the invention, the environment ensures that for every piece of information used in a running service it is known to whom the information is private, and to whom the information is public. This is referred to as the privacy access rights of the information described in this paragraph.

In accordance with an aspect of the invention, the environment ensures that the privacy rights of information remain consistent across information manipulations.

In accordance with another embodiment of the invention, a “privacy firewall” algorithm is provided which can determine whether or not transmission of certain information to a recipient is allowed.

In accordance with an aspect of the invention, the “privacy firewall” asks the end user for permission to transmit data if its algorithm finds that transmission isn't allowed.

In accordance with an aspect of the invention, private information may be provided to the service directly by the end user.

In accordance with an aspect of the invention, private information may be provided to the service by the execution environment, which either previously received it from the user, or which has direct access to such information.

These and other aspects of the invention will become readily apparent to those of ordinary skill in the art from the following description of the invention, which is to be read in conjunction with the accompanying drawings and appended claims.

### BRIEF DESCRIPTION OF THE DRAWINGS

FIG. 1 depicts the basic architecture of service creation and usage using development and execution environments;

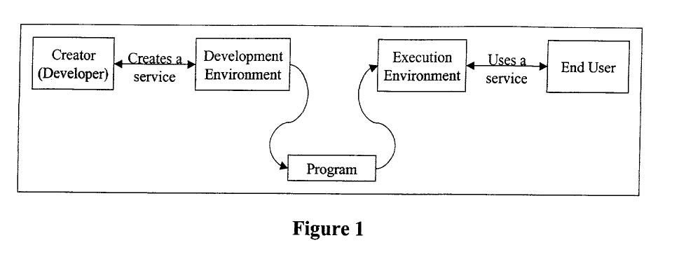

FIG. 2 depicts the application of this architecture when the execution environment is embedded in a device owned by the User, which can be the case when the execution environment consists of a script interpreter or a virtual machine;

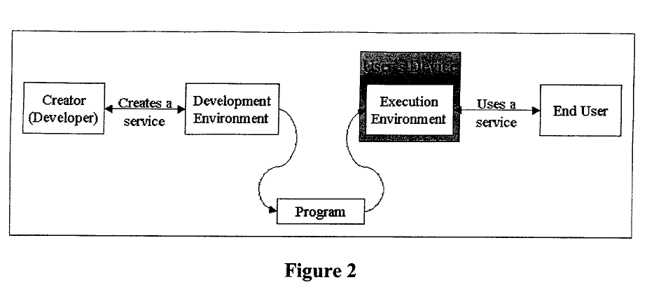

FIG. 3 depicts the application of this architecture when both the development and the execution environment are embedded in a trusted platform;

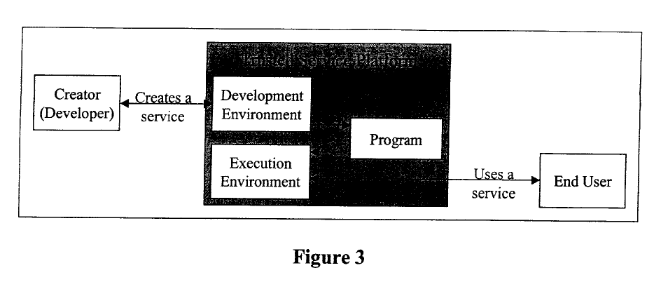

FIG. 4 provides further details on the Privacy Firewall algorithm;

FIG. 5 depicts a screen shot of an exemplary information transmission approval requester.

FIG. 6 shows how a simple pizza ordering service was built in accordance with the present invention, and what the end-user might see when trying to use it on a platform equipped with a Privacy Firewall.

FIG. 7 illustrates how the privacy access rights of a new variable are set when it is based on 3 existing variables.

### DETAILED DESCRIPTION OF THE INVENTION

The Privacy Firewall is an enhancement that can be made to a conventional programming environment. Specifically, the privacy firewall requires the following:

(a) Every variable must have privacy access rights associated with it.

(b) Only fully trusted parties are allowed to modify the privacy access rights of a variable.

(c) The compiler, interpreter, and/or virtual machine must ensure that the privacy access rights remain consistent and up to date during the execution of an application.

(d) Before transmitting, displaying, or by whatever method conveying the information contained in a variable to someone (a recipient), the privacy access rights of the variable must be verified to ensure that the recipient is allowed to see the information contained therein.

(e) If a part of the execution flow of an application is impacted by a variable “a”, all newly created variables, as well as any information transmitted during the impacted portion of the execution flow, must also comply with the privacy access rights of variable “a”.

1. Variables with Privacy Access Rights.

The privacy firewall requires a development environment and an execution environment in which every variable has privacy access rights associated with it.

In the most simplistic implementation, every variable has a uniquely associated boolean value which defines whether or not the variable is confidential. If the variable is defined as confidential, then only the user person about whom the variable reveals something) is allowed to see it. In order to display the variable to someone else, the explicit permission of the user is required.

In a more complex implementation, each variable could have a unique list (Access Control List or ACL) associated with it which is made up of entities (people or other programs) and groups of entities who are allowed to see the contents of the variable. If this list is empty, no one other than user is allowed to see the content of a variable without explicit permission. If the ACL contains the “ALL” token, everyone is allowed to see it.

Example 1 shows how some confidential variables could be setup using an ACL mechanism in a simple Java-inspired programming language.

Example 1: Assigning privacy access rights to variables.

| | |
|---|---|
| String FirstName = “Alain”; | |
| String LastName = “Penders”; | |
| String CreditCard = “1234567890”; | |
| FirstName.privacy = ALL; | // Everyone can see it. |
| LastName.privacy = GROUPS(Family)+USERS(Boss); | // Only users family and boss can see it. |
| CreditCard.privacy = null; | // Only user can see it. |

2. Only Trusted Parties can Modify Privacy Access Rights.

The above example code should work only if the party who wrote the code is fully trusted by the user. If a non-trusted party wrote the code, modifying the privacy access rights of variables would not be allowed, and the code should—in Java style—throw a privacy-violation exception.

If a trusted party wrote the code, it would be allowed to set and change the privacy access rights of variables. For example, if the user himself wrote the code, it can be assumed that the code isn't malicious, and hence the privacy access rights can be modified.

The execution environment before or during the program execution can define variables with appropriate privacy access rights. This could be done—for example—when the programming environment is housed in an environment in which information about the user is already known (and which as such can be considered a trusted environment). One such environment, for example, is the network of a wireless carrier, where the identity, address, credit card number, and location of the end-user is known, and where a trust relationship exists between the end-user and the carrier. In such an environment the program could be written by an untrusted (and possibly unknown) party. All confidential information to which the program has access is set up in advance, and the program itself cannot modify any of the privacy access rights, that way protecting the private information of the user. In such an environment, it's not even necessary for the programming language to support changing a variables privacy access rights.

An untrusted program can use trusted functions that are available in the programming environment to request new information from the user. For example, the program could use a function to request the user's address. As the function handling this input from the user is trusted, this function can set appropriate privacy access rights on the new variable before the untrusted program can start using it. If the programming environment only supports data input through trusted functions, then all information provided by the user can be appropriately protected.

In a Java-like language, this can be implemented by forbidding the usage of untrusted Java Native Interface (JNI) classes. This limits the untrusted classes to using existing classes for handling input, and all existing classes would be trusted, secure, and impossible to override. Another approach is to create a scripting language, which only provides a trusted function set for input purposes.

3. Consistency of the Privacy Access Rights.

The programming environment must ensure that the privacy access rights remain consistent across variable modifications and assignments. For example, when a new variable is declared based on an existing one, the new variable must inherit the privacy access rights of the existing variable.

In the case of ACLs, as described above, when a new variable is declared based on multiple existing variables, the ACL for the new variable must be the intersection of the ACLs of the variables it is based on. This is illustrated in example 2.

Example 2: Intersection of the privacy access rights.

// Group “family” is defined as father, mother, brother, and sister.
// Group “friends” is defined as Jenn, Doug, Jerri, and Dave.
// Group “parents” is defined as father and mother.
String FirstName = “Alain”;
String LastName = “Penders”;
String Age = “28”;
FirstName.privacy = GROUPS(Family, Friends);
LastName.privacy = GROUPS(Family) +USERS (Jenn, Doug);
Age.privacy = GROUPS(Parents, Friends);
String Me = FirstName + LastName + Age; // result: GROUPS(Parents)+USERS(Jenn, Doug)

The ACL for the new variable Me is the intersection of the people who have access to the original variables, which results in GROUPS(Parents)+USERS(Jenn, Doug) (all entities who had permission to see all of the original variables). If any of the three variables has “null” (no one) as its ACL, the new variable would always have the empty ACL as well (and hence be visible to no one other than the user). When a new variable is defined and not based on an existing variable, the ACL for this variable is always “ALL” (visible to everyone). See point 5 below for an additional rule, which will impact the actual privacy access rights assigned to a new variable.

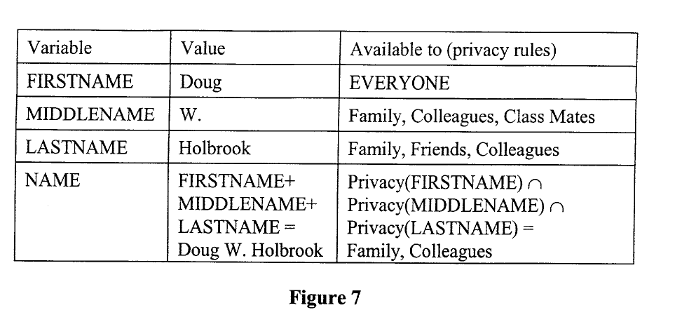

How the intersection of variable privacy access rights works is also illustrated by FIG. 7.

To implement the variable privacy access rights consistently, the consistency must be enforced by the compiler, interpreter, and/or virtual machine that processes the untrusted program. How this is done should be apparent to those of ordinary skill in the art of compiler, interpreter, and virtual machine design.

4. Privacy Firewall on Variable Transmission.

Before transmitting or in any way conveying the information contained in a variable to a recipient, the programming environment must verify that the recipient is allowed to see the information. If the recipient does not have permission, the programming environment should ask the user whether or not recipient is allowed to see the information contained in the variable. If the user allows recipient to see it, the service continues normally and the information is passed to recipient. If the user rejects the request, or the programming environment for some reason does not ask the user or is unable to ask the user, either the service is ended, or it continues after skipping the action that would make the information contained in the variable visible to the recipient. This process is called the Privacy Firewall.

The case where the programming environment is unable to ask the user for permission can occur, for example, when the service is started by an event (e.g., a stock value going below a certain threshold), and runs without interaction with the user.

This feature can be implemented by making trusted function calls the only way to transmit or display the information contained within variables outside of the programming environment. In a Java virtual machine this can be done by disabling the addition of Java Native Interface (JNI) classes, and by only making trusted classes available for information output, identical to the input classes described in point 2. In a scripting language this can be accomplished by only providing trusted output functions.

5. Impact of the Execution Flow.

One addition needs to be made to the variable handling described above to make a reliable privacy firewall. With only the above rules in place, it is possible for a service developer to still transmit confidential information by using the confidential information to determine the execution flow of the service. This is illustrated in examples 3 and 4 below.

String Age = “28”; // Ages privacy settings are GROUPS(Family, Friends)
switch (Age)
{

case 1:

transmit (1);
break;

case 2:

transmit (2);
break;

case 3:

transmit (3);
break;

// etc.
}

### Example 3

### Using Execution Flow to Circumvent Privacy Access Rights

String Age = “28”; // Ages privacy settings are GROUPS(Family, Friends)
int a;
switch (Age)
{

case 1:

a=1;
break;

case 2:

a=2;
break;

case 3:

a=3;
break;

// etc.
}
transmit (a);

### Example 4

### Using Execution Flow to Circumvent Privacy Access Rights

Since all of the information contained in the variables and constants transmitted in examples 3 and 4 have their privacy access rights set to the ALL token (ACL-style implementation), this method would allow the user's age to be transmitted to anyone without ever triggering the privacy firewall. Obviously this is unwanted.

To counter this sort of violation, the programming environment must track the intersection of the privacy access rights of all variables that have influenced the execution flow at a certain point in the execution of a service. The resulting privacy access rights (which dynamically change throughout the execution of a service), are further referred to as the “execution flow privacy access rights”. When the execution flow isn't based on any variable, the execution flow privacy access rights must be set to totally non-confidential (ALL-token).

When a new variable is created, its privacy access rights must be set to the intersection of both the privacy access rights of all variables that it is based on and the execution flow privacy access rights. This means that when a new variable is defined with a constant value (not based on another variable), the new variable's privacy access rights will be set to the execution flow privacy access rights, which isn't necessarily the ALL token as described in point 3.

Additionally, when a function is used to transmit information to a recipient, the function must include the execution flow privacy access rights when checking whether or not the recipient is allowed to see the information. This check must be performed in addition to the privacy access rights check of the variable the function wants to transmit. When the function wants to transmit a constant (as illustrated by example 1 above), the privacy access rights that apply to the transmission are equal to the execution flow privacy access rights. If the function wants to transmit the information contained in a single variable, then the privacy access rights that apply to the transmission are equal to the intersection of the variable's privacy access rights with the execution flow privacy access rights.

A concrete implementation of this rule is described below.

6. Implementation.

On a software platform, service creators (which can be users, the platform owner, a (untrusted) third party developer, etc.) can create services using the Open Service Creation Environment as described in patent SYSTEM AND METHOD FOR ON-LINE SERVICE CREATION (application Ser. No. 09/643,749). Within the Open Service Creation Environment (OSCE), they create a service by linking building blocks together and configuring them. Internal to the platform, the service is converted into a Generic Programming Language (GPL) Script, which uses the equivalent of function calls to call code representing certain building blocks. (Some building blocks are converted totally into GPL, and don't require any function calls.)

GPL is an XML-based scripting language, which is interpreted when the service is executed. The execution of a service always starts on behalf of a specific user. Either because the user directly requested the start of the service (e.g., by clicking on it), or because the user set up an event that triggered the start of the service (e.g., on an incoming email).

When the execution of a service is requested, the platform starts by filling variables with information about the user on who's behalf the service will run, and sets appropriate privacy access rights on each of these variables. The privacy access rights are set using an Access Control List (as described in point 1), which gets attached to the internal structure for each variable. The ACL is a linked list in which each node identifies one or more people as privileged to see the variable. Three types of nodes are defined: ALL (everyone can see the variable), USER (a specific user can see the variable), and GROUP (a specific group can see the variable).

For example, the variables FirstName, LastName, Age, StreetAddress, City, Zip, and PhoneNumber may all be set by the platform. The information with which to set these variables is retrieved from the platform's user database, which is populated when the user becomes a customer or subscriber of the platform owner. The presence of this information implies that the user trusts the platform owner. The privacy access rights (ACLs) that the variables are initialized with are based on what the user requests, the defaults set by the platform owner, and the defaults set by the platform itself (in that order of priority). The defaults set by the platform owner should reflect the legal requirements for privacy protection in the country where the platform is operated.

The presence of these variables allows a service creator to use them in the service, and base decisions within the service on the information contained in the variables. For example, a service may work differently depending on whether the user is male or female, and on the age of the user. As long as the service only uses the private information to personalize the service for the specific user, and does not attempt to transmit the information to the service creator or a third party, the program will always run without being interrupted by the privacy firewall. The service creator knows that these variables exist and can use them during the creation of the service. The variables are either not defined during the creation (when the service creator can see them), or are defined and contain the confidential information of the service creator himself.

Another variable which is initialized before the execution of the service begins is the EXEC variable, which implements the execution flow privacy access rights as described in point 5. The value of the EXEC variable is unimportant, but its ACL is very important throughout the execution of a service. When the EXEC variable is created, its ACL is set to the ALL token.

All of the variables created before the service execution begins are set to read-only, preventing the GPL program from changing their value.

Once these variables are initialized, the software platform starts interpreting (executing) the GPL program. The GPL programming language does not support changing the privacy access rights of variables directly. All privacy access rights changes are made by code outside of the GPL script.

Each time the program makes a program flow decision based on one or more variables, the EXEC variable's ACL is pushed on a dedicated stack, and it is set to the intersection of its existing ACL with those of the variables. When the program flow exits the code section in which a flow decision was based on those variables, the EXEC variable is reverted to its previous ACL, which is popped from the stack. This is illustrated by the code in example 5, which shows the ACL changes for the EXEC variable in comments.

// Exec.privacy = ALL;
if (Age > 18)
{

// Exec.privacy ALL ∩ Age.privacy
if (FirstName.equals (LastName))
{

// Exec.privacy = ALL ∩ Age.privacy ∩ FirstName.privacy ∩ LastName.privacy
int a = 1; // a.privacy = Exec.privacy
String address = Street + StreetNumber;

// address.privacy = Exec.privacy ∩ Street.privacy ∩ StreetNumber.privacy

}
// Exec.privacy = ALL ∩ Age.privacy

}
// Exec.privacy = ALL;

### Example 5

### Execution Flow Privacy Access Right Behaviour

When a new variable is created, or a variable value is changed, its ACL is set to the intersection of the ACLs of all variables it is based on and that of the EXEC variable at that time. If a new variable is based on constants (not an existing variable), the ACL for the variable is always the same as the ACL for the EXEC variable at that time. (See example 5.)

Outside of the variables created before the service execution starts, and the new variables created by the GPL program (based on existing variables and constant data), the only other way to create or modify variables is through function calls. All function calls available in a GPL main program or subroutine is trusted code (abiding the privacy firewall rules) representing a building block. As each building block is used for a specific purpose, the building block code is capable of setting a correct ACL on each variable it creates or modifies. Examples of building blocks that set new variables include the building block to retrieve a users location, the financial information building block, and the weather information building block. If the building block code isn't 100% certain of the correct ACL for a new variable (e.g., a variable based on an input field configured by the service creator), the code will always opt towards the strictest ACL required.

Similarly, the only way of making data available to third parties outside of the platform is through trusted building block code (a function). When using a trusted function to display or somehow transmit information, the function always uses the privacy firewall algorithm to verify that the data transmission is allowed.

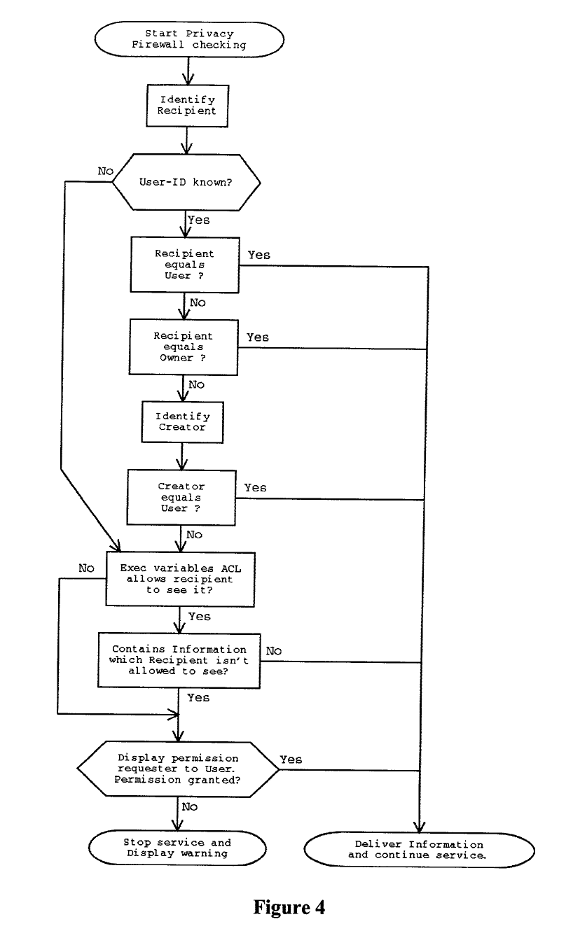

FIG. 4 gives an overview of the privacy firewall algorithm used in the platform. Whenever the GPL program calls a function that delivers information outside of the platform, the function will invoke the privacy firewall algorithm, providing it information about the current user, which variables are being transmitted, and the address of the recipient. The first step taken by the algorithm is to identify the recipient, turning the recipient address into a specific User-ID. If no User-ID can be found for the recipient, a number of the following checks are not useful, and skipped, as shown in FIG. 4. This can happen when the recipient is identified by an address that isn't associated with any user in the database, there are multiple recipients, or the recipient is identified by an application id that isn't associated with a trusted external application. Next the algorithm checks whether the recipient is the user or the platform owner (who is trusted by the user), and if so, allows the transmission. The algorithm then checks who created the service, and if it was created by the user, it allows the delivery of the data (a user would never create a service that transmits his own confidential data to people who shouldn't have it). The algorithm then checks if the current EXEC variables ACL allows the transmission of data to the recipient. This is used to prevent a malicious programmer from using variables to influence the program flow, and that way release confidential data, as described before. If it's found in this check that the recipient is not allowed to see the data, the next and last check—which could still approve the data to be shown to the recipient—is skipped. The last check is whether or not the recipient is actually allowed to see the information contained in the variables to be transmitted. If the recipient is allowed to see the information, the transmission is performed. Note that the receiver may not have been identified by User-ID for the last two tests, in which case it only matters whether or not the information is visible to ALL.

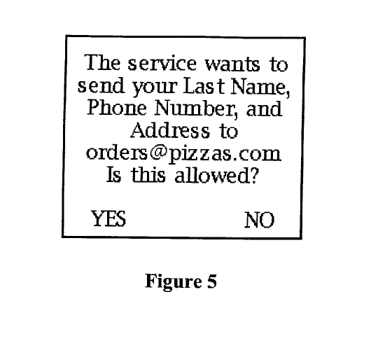

If after these checks the transmission is still denied, the privacy firewall makes a last attempt at getting permission by asking the user directly. This is done by showing a requester such as the one shown in FIG. 5 to the user. If for some reason this requester cannot be shown to the user, the transmission is always rejected. This may occur, for example, when the service being executed is a push service (started based on an event such as a timer), and the user on whose behalf the service is executed has his wireless device turned off. In the requester, the user is presented with the choice to reject (No) or to approve (Yes) the transmission.

To allow the user to make an educated decision on whether or not to approve the transmission, the privacy firewall algorithm always provides all information needed to identify exactly what information will be transmitted to what recipient. When the EXEC variable's ACL allows the recipient to see the transmitted data, the information provided to the end-user includes (a) information identifying the recipient, (b) all read-only confidential variables, and (c) all other confidential variables and their contents. Variables which the user is allowed to see (and which wouldn't have triggered the privacy firewall) are not displayed. The read-only confidential variable names were determined before the program began execution. They can't be modified by the program, and have names that identify exactly what information is being transmitted. Therefore, the user is presented with the names of the confidential variable and not their content (e.g. LastName instead of Penders). When the EXEC variable's ACL does not allow the current recipient to see the information being transmitted, all information to be transmitted (independent of it's type and privacy access rights) is displayed to the user for approval. Based on this information, the user can then decide whether to allow or reject the transmission of the information.

When the privacy firewall algorithm grants approval for transmitting the information, it returns a success code. The function performs the transmission, and the normal service execution continues. If the privacy firewall rejects the approval, it returns a failure code. The function immediately returns with an interpreter-level failure code, upon which the interpreter ends the execution of the service.

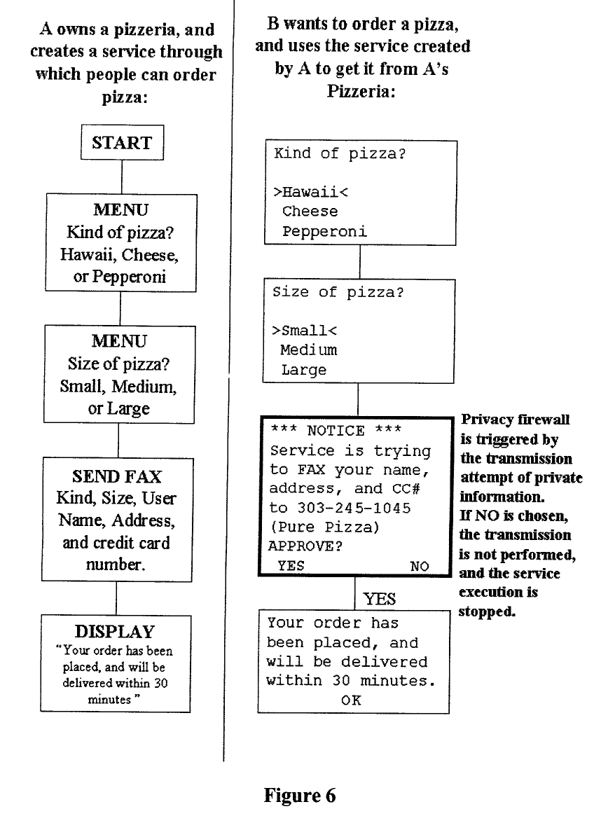

An example of what a service created on the platform would look like, and what the end-user might see is given in FIG. 6. It illustrates a simple service to order a pizza created by the owner or affiliate of a pizza restaurant. The end-user is prompted to select the style and size of the pizza he wants, after which it will be delivered to his home address. It is assumed that a wireless carrier, who knows the name, address, phone number, and credit card number of the end-user, hosts the platform. The end-user will not have to enter this information to complete the order, as the service has access to it. When the service tries to transmit his name, address, and credit card number, however, the privacy firewall finds that private information is being transmitted, and asks the user whether or not this is allowed. If the users answers yes, a fax with the order and the users information is sent to the pizza restaurant. If the users answers no, the service ends immediately without transmitting anything.

What is claimed is:

1. A method for controlling access to personal information, comprising:
establishing at least one of a service development environment and an execution environment on a computer in electronic communication with a distributed network; collecting information from a user;
establishing privacy access rights for said information;
engaging in an electronic transaction that requires transmission of said information through said distributed network;
applying said privacy access rights to said information, to select a portion of said information to be transmitted; and
transmitting said portion of said information.

2. The method of claim 1 wherein said information is selected from the group consisting of personal identification information, residence information, employment information, financial information, at least one credit card number, and combinations thereof.

3. The method of claim 1 wherein said distributed network is the internet.

4. The method of claim 1 wherein said environment comprises an execution environment that allows a user to employ a service.

5. The method of claim 1 wherein said environment comprises a development environment for creating a service.

6. The method of claim 5 wherein said execution environment operates within said development environment.

7. The method of claim 1 wherein said privacy access rights comprise variables indicating recipients for whom said information is public.

8. The method of claim 1 wherein a privacy firewall is provided for applying said privacy access rights to said information.

9. The method of claim 1 further comprising determining whether said information is private with respect to said recipient and denying the transmission of data after applying said access restrictions to said information.

10. A method for controlling access to personal information transmitted over a distributed network comprising:
creating an environment comprising a service development environment and an execution environment, wherein said development environment is a service run by said execution environment; said environment further comprising a privacy firewall;
establishing privacy access rights for at least some information processed in said environment, wherein said privacy access rights includes a privacy attribute for said information;
receiving a request to transmit said information from a requestor;
determining whether said privacy attribute for said information is public or private with respect to said requestor;
notifying an end user when the privacy attribute of said information is private with respect to said requestor; or
transmitting said information to said requestor when said privacy attribute is public with respect to said requestor.
